(19) United States
(12) Patent Application Publication
(10) Pub. No.: US 2021/0358376 A1
(43) Pub. Date: Nov. 18, 2021

(54) COMPENSATION METHOD AND EMBEDDED TOUCH DISPLAY PANEL

(71) Applicant: WUHAN CHINA STAR OPTOELECTRONICS TECHNOLOGY CO., LTD., Wuhan (CN)

(72) Inventor: Jianghong Tang, Wuhan (CN)

(73) Assignee: WUHAN CHINA STAR OPTOELECTRONICS TECHNOLOGY CO., LTD., Wuhan (CN)

(21) Appl. No.: 16/344,052

(22) PCT Filed: Feb. 22, 2019
(86) PCT No.: PCT/CN2019/075800

§ 371 Date: Apr. 23, 2019

(30) Foreign Application Priority Data
Jul. 24, 2018 (CN) 201810819013.X

(51) Int. Cl. G09G 3/20; G06F 3/041; G09G 3/36

(52) U.S. Cl. CPC G09G 3/2007; G06F 3/0412; G09G 3/36; G09G 2300/0426; G09G 2310/08; G09G 2320/0285; G09G 2320/0233

(57) ABSTRACT

A compensation method and an embedded touch display panel are provided. The method includes storing a grayscale luminance compensation data table in a timing controller; searching, from the grayscale luminance compensation data table, for a grayscale luminance compensation value corresponding to the present grayscale in each of the plurality of pixel regions according to a present grayscale of the embedded touch display panel; determining whether the grayscale luminance compensation value corresponding to the present grayscale in each of the plurality of pixel regions is equal to a predetermined grayscale luminance compensation value; and adjusting a voltage on one of the plurality of common electrodes corresponding to a corresponding one of the plurality of pixel regions if the grayscale luminance compensation value corresponding to the present grayscale in each of the plurality of pixel regions is not equal to the predetermined grayscale luminance compensation value.

### FIELD OF INVENTION

The present application generally relates to the display technology and, more particularly, to a compensation method and an embedded touch display panel.

### BACKGROUND OF INVENTION

Due to the flaws in the manufacturing process of an embedded touch display panel, the luminance is often uneven, forming a variety of mura defects (which refer to the non-uniform luminance of a display panel, causing various traces).

In order to improve the luminance uniformity of an embedded touch display panel, the existing compensation method achieves a relatively uniform luminance of an embedded touch display panel by converting the grayscale luminance compensation value of each pixel into a corresponding voltage and loading it onto the pixel electrode. However, it needs to store the grayscale luminance compensation values of all the pixels on the embedded touch display panel, so that the embedded touch display panel requires a large amount of storage capacity, resulting in high cost and low efficiency.

Therefore, such conventional technology is flawed and needs to be improved.

### SUMMARY OF INVENTION

One object of the present application is to provide a compensation method and an embedded touch display panel, which can reduce the product cost while improving the display performance of the embedded touch display panel.

One embodiment of the present application provides a compensation method applicable to an embedded touch display panel including a plurality of pixel regions and a plurality of common electrodes in one-to-one correspondence, the compensation method including:

storing a grayscale luminance compensation data table in a timing controller, the grayscale luminance compensation data table being used for grayscale compensation on the embedded touch display panel;

acquiring a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;

determining whether the grayscale luminance compensation value corresponding to the present grayscale in each of the plurality of pixel regions is equal to a predetermined grayscale luminance compensation value;

adjusting a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value;

the compensation method further including:

determining that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value;

wherein each of the plurality of pixel regions includes a plurality of pixels, and the grayscale luminance compensation value of one of the plurality of pixel regions is an average value of grayscale luminance compensation values of the plurality of pixels in one of the plurality of pixel regions.

In the compensation method of the present application, the step of adjusting the voltage on the one of the plurality of common electrodes corresponding to the corresponding one of the plurality of pixel regions to conduct grayscale compensation on the present grayscale of the embedded touch display panel includes:

acquiring a common electrode voltage corresponding to the corresponding one of the plurality of pixel regions according to the grayscale luminance compensation value corresponding to the present grayscale in the corresponding one of the plurality of pixel regions; and

outputting the common electrode voltage to the one of the plurality of common electrodes corresponding to the corresponding one of the plurality of pixel regions.

In the compensation method of the present application, the grayscale luminance compensation data table includes N grayscale luminance compensation data sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

In the compensation method of the present application, the step of searching, from the grayscale luminance compensation data table, for the grayscale luminance compensation value corresponding to the present grayscale in each of the plurality of pixel regions according to the present grayscale of the embedded touch display panel includes:

acquiring a corresponding grayscale luminance compensation data sub-table according to the present grayscale of the embedded touch display panel; and

searching, from the grayscale luminance compensation data sub-table, for the grayscale luminance compensation value corresponding to each of the plurality of pixel regions.

In the compensation method of the present application, the grayscale luminance compensation data table includes the grayscale luminance compensation value of each of the plurality of pixel regions with a grayscale from 0-255.

One embodiment of the present application further provides a compensation method applicable to an embedded touch display panel including a plurality of pixel regions and a plurality of common electrodes in one-to-one correspondence, the compensation method including:

storing a grayscale luminance compensation data table in a timing controller, the grayscale luminance compensation data table being used for grayscale compensation on the embedded touch display panel;

acquiring a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;

determining whether the grayscale luminance compensation value corresponding to the present grayscale in each of the plurality of pixel regions is equal to a predetermined grayscale luminance compensation value; and

adjusting a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value.

In the compensation method of the present application, the compensation method, further including:

determining that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value.

In the compensation method of the present application, the step of adjusting the voltage on the one of the plurality of common electrodes corresponding to the corresponding one of the plurality of pixel regions to conduct grayscale compensation on the present grayscale of the embedded touch display panel includes:

acquiring a common electrode voltage corresponding to the corresponding one of the plurality of pixel regions according to the grayscale luminance compensation value corresponding to the present grayscale in the corresponding one of the plurality of pixel regions; and

outputting the common electrode voltage to the one of the plurality of common electrodes corresponding to the corresponding one of the plurality of pixel regions.

In the compensation method of the present application, the grayscale luminance compensation data table includes N grayscale luminance compensation data sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

In the compensation method of the present application, the step of searching, from the grayscale luminance compensation data table, for the grayscale luminance compensation value corresponding to the present grayscale in each of the plurality of pixel regions according to the present grayscale of the embedded touch display panel includes:

acquiring a corresponding grayscale luminance compensation data sub-table according to the present grayscale of the embedded touch display panel; and

searching, from the grayscale luminance compensation data sub-table, for the grayscale luminance compensation value corresponding to each of the plurality of pixel regions.

In the compensation method of the present application, each of the plurality of pixel regions includes a plurality of pixels, and the grayscale luminance compensation value of one of the plurality of pixel regions is an average value of grayscale luminance compensation values of the plurality of pixels in one of the plurality of pixel regions.

In the compensation method of the present application, the grayscale luminance compensation data table includes the grayscale luminance compensation value of each of the plurality of pixel regions with a grayscale from 0-255.

One embodiment of the present application further provides an embedded touch display panel including a plurality of pixel regions and a plurality of common electrodes in one-to-one correspondence, wherein the embedded touch display panel further includes:

a storage unit configured to store a grayscale luminance compensation data table in a timing controller, the grayscale luminance compensation data table being used for grayscale compensation on the embedded touch display panel;

an acquisition unit configured to acquire a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;

a determining unit configured to determine whether the grayscale luminance compensation value corresponding to the present grayscale in each of the plurality of pixel regions is equal to a predetermined grayscale luminance compensation value; and

a first processing unit configured to adjust a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value.

In the embedded touch display panel of the present application, the embedded touch display panel further includes:

a second processing unit configured to determine that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value.

In the embedded touch display panel of the present application, the first processing unit is further configured to:

acquire a common electrode voltage corresponding to the corresponding one of the plurality of pixel regions according to the grayscale luminance compensation value corresponding to the present grayscale in the corresponding one of the plurality of pixel regions; and

output the common electrode voltage to the one of the plurality of common electrodes corresponding to the corresponding one of the plurality of pixel regions.

In the embedded touch display panel of the present application, the grayscale luminance compensation data table includes N grayscale luminance compensation data sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

In the embedded touch display panel of the present application, the acquisition unit is further configured to:

acquire a corresponding grayscale luminance compensation data sub-table according to the present grayscale of the embedded touch display panel; and

search, from the grayscale luminance compensation data sub-table, for the grayscale luminance compensation value corresponding to each of the plurality of pixel regions.

In the embedded touch display panel of the present application, each of the plurality of pixel regions includes a plurality of pixels, and the grayscale luminance compensation value of one of the plurality of pixel regions is an average value of grayscale luminance compensation values of the plurality of pixels in one of the plurality of pixel regions.

In the embedded touch display panel of the present application, the grayscale luminance compensation data table includes the grayscale luminance compensation value of each of the plurality of pixel regions with a grayscale from 0-255.

The compensation method and the embedded touch display panel of the present application store a grayscale luminance compensation data table in a timing controller, acquire a present grayscale of the embedded touch display panel, and search, from the grayscale luminance compensation data table, for a grayscale luminance compensation value corresponding to the present grayscale in each of the plurality of pixel regions according to the present grayscale of the embedded touch display panel, determine whether the grayscale luminance compensation value corresponding to the present grayscale in each of the plurality of pixel regions is equal to a predetermined grayscale luminance compensation value, and adjust a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value. Compared with the conventional technology, the present application only needs to store the grayscale luminance compensation value corresponding to each pixel region, and the stored amount of data is relatively small and can be stored in the timing controller of the embedded touch display panel, which can reduce the product cost while improving the display performance of the embedded touch display panel.

### DESCRIPTION OF DRAWINGS

In order to more clearly illustrate the technical solutions in the embodiments or the prior art, the drawings used in the embodiments or the prior art description will be briefly described below. Obviously, the drawings in the following description are only some implementations of the present application. For example, other drawings may be obtained, without creative efforts, by those of ordinary skill in the art in light of the inventive work.

FIG. 1 is a perspective schematic structural view of an embedded touch display panel according to one preferred embodiment of the present application;

FIG. 2 is an exploded perspective view of the embedded touch display panel as shown in FIG. 1;

FIG. 3 is a schematic diagram showing the equivalent circuit of a driving structure and a pixel electrode layer;

FIG. 4 is a schematic diagram showing the correspondence between the common electrode shown in FIG. 2 and the pixel region shown in FIG. 3;

FIG. 5 is a schematic flowchart of a compensation method of the present application according to one preferred embodiment of the present application; and

FIG. 6 is a schematic diagram of an embedded touch display panel according to one preferred embodiment of the present application.

### DETAILED DESCRIPTION OF PREFERRED EMBODIMENTS

The embodiments of the present application are described in detail below, and the examples of the embodiments are illustrated in the accompanying drawings, in which the same or similar reference numerals refer to the same or similar elements or elements having the same or similar functions. The described embodiments are exemplary and are only used to explain the present application, instead of being construed as a limitation on the present application.

In the description of the present application, it is to be understood that the orientations or the positional relationships of the terms “center”, “longitudinal”, “transverse”, “length”, “width”, “thickness”, “upper”, “lower”, “front”, “back”, “left”, “right”, “vertical”, “level”, “top”, “bottom”, “inside”, “outside”, “clockwise”, “counterclockwise”, etc. are based on the orientations or the positional relationships shown in the drawings, for the convenience of describing the present application and the simplifying the descriptions, instead of indicating or implying that the device or component referred to has a particular orientation in a particular configuration and orientation, cannot be construed as a limitation on the present application. In addition, the terms “first” and “second” are used for descriptive purposes only and are not to be construed as indicating or implying relative importance or implicit indication of the number of indicated technical features. Therefore, the number of “first”, “second” features may be explicitly or implicitly included in one or more of the described features. In the description of the present application, the meaning of “multiple” is two or more than two, unless otherwise specifically defined.

In the description of the present application, it should be noted that the terms “installation”, “interconnection”, and “connection” should be understood broadly, unless otherwise clearly defined and limited. For example, it may be fixed connection or detachable connection, or integrated connection, it may be mechanical connection, electrical connection or intercommunication, it may be direct connection or indirect connection through an intermediate medium, or it may be internal communication of two components or mutual interaction of two components. For those with ordinary skill in the art, specific meanings of the above terms in the present application can be understood on a case-by-case basis.

In the present application, the expression of the first feature being “above” or “under” the second feature may include direct contact of the first and second features, and may also include indirect contact through other feature between the first and second features, unless otherwise specifically stated and defined. Moreover, the expression of the first feature being “on”, “above” or “over” the second feature includes the first feature being right above or obliquely above the second feature or merely indicates that the level of the first feature is higher than that of the second feature. The expression of the first feature being “under”, “beneath”, or “below” the second feature may include the first feature being right below or obliquely under the second feature or merely indicates that the level of the first feature is lower than that of the second feature.

The following disclosure provides a number of different implementations or examples for implementing the different structures of the present application. To simplify the disclosure of the present application, the components and settings of the specific examples are described below. Certainly, they are merely examples, and are not intended to limit the present application. In addition, the present application may repeat reference numerals and/or reference letters in different examples. Such repetition is for the purpose of simplicity and clarity, and does not indicate the relationship between the various embodiments and/or the settings. In addition, the present application provides examples of various specific processes and materials, but those of ordinary skill in the art will be aware of the application of other processes and/or the use of other materials.

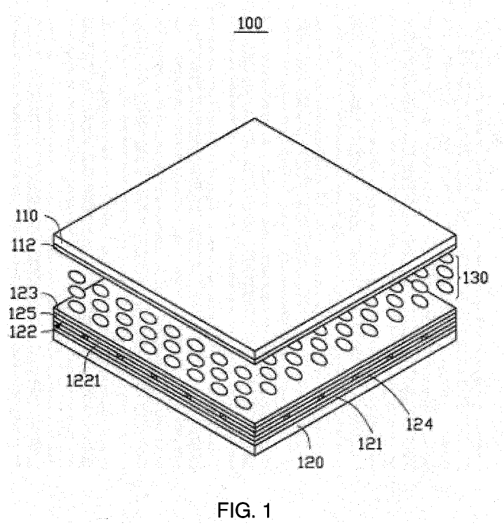

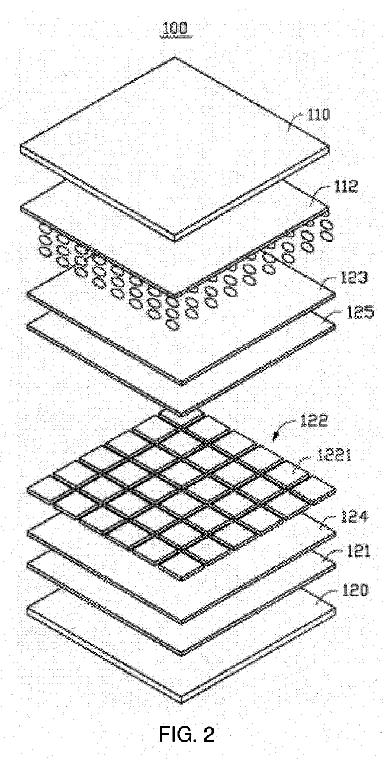

Referring to FIG. 1 and FIG. 2, FIG. 1 is a perspective schematic structural view of an embedded touch display panel according to one preferred embodiment of the present application and FIG. 2 is an exploded perspective view of the embedded touch display panel as shown in FIG. 1. As shown in the above figures, the embedded touch display panel 100 includes a color filter substrate 110, an array substrate 120, and a liquid-crystal layer 130 between the color filter substrate 110 and the array substrate 120. A color filter layer 112 is provided on one side of the color filter substrate 110 adjacent to the liquid-crystal layer 130. A display driving structure 121, a common electrode layer 122, and a pixel electrode layer 123 are provided on one side of the array substrate 120 adjacent to the liquid-crystal layer 130.

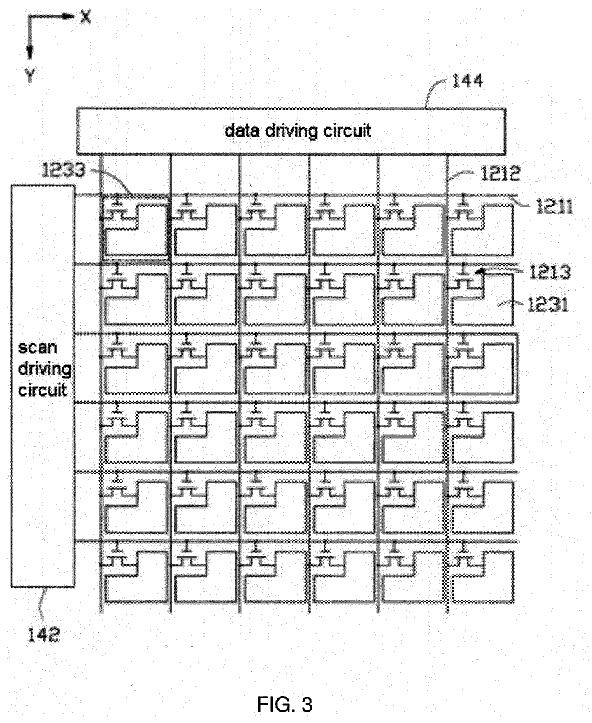

Specifically, please refer to FIG. 3, which is a schematic diagram showing the equivalent circuit of a driving structure and a pixel electrode layer. The pixel electrode layer 123 includes a plurality of pixel electrodes 1231, each of which corresponds to one of a plurality of pixels on the embedded touch display panel 100. The display driving structure 121 includes a plurality of scan lines 1211, a plurality of data lines 1212 and a plurality of thin-film transistors 1213, each connected to the intersection of one of the scan lines 1211 and one of the data lines 1212. The thin-film transistors 1213 are further electrically connected to the pixel electrodes 1231 for transmitting data signals to the pixel electrodes 1231. The common electrode layer 122 is configured to cooperate with the pixel electrodes 1231 to form a planar electric field to drive liquid-crystal molecules to rotate on a plane. The scan lines 1211 extend along a first direction X, and the data lines 1212 extend along a second direction Y different from the first direction X and are insulated from the scan lines 1211 to form a plurality of pixels 1233. The first direction X may be perpendicular to the second direction Y, so that the plurality of pixels 1233 are arranged in a matrix. Among them, each pixel 1233 is provided with a thin-film transistor 1213 and a pixel electrode 1231. The thin-film transistor 1213 is respectively connected to one of the scan lines 1211, one of the data lines 1212, and the pixel electrode 1231, which is used to work with the common electrode layer 122 to drive the embedded touch display panel 100 to display during the display period.

Furthermore, it can be understood that the embedded touch display panel 100 further includes a scan driving circuit 142 electrically connected to the scan lines 1211 and a data driving circuit 144 electrically connected to the data lines 1212. The scan driving circuit 142 is configured to apply a scan driving signal to the scan lines 1211 in the display period, while the data driving circuit 144 is configured to apply a data driving signal to the data lines 1212 during the display period.

The embedded touch display panel 100 further includes a first insulating layer 124 and a second insulating layer 125. The display driving structure 121 is disposed on a surface on one side of the array substrate 120 adjacent to the liquid-crystal layer 130. The first insulating layer 124 is disposed on a surface on one side of the display driving structure 121 adjacent to the liquid-crystal layer 130. The common electrode layer 122 is disposed on a surface on one side of the first insulating layer 124 adjacent to the liquid-crystal layer 130. The second insulating layer 125 is disposed on a surface on one side of the common electrode layer 122 adjacent to the liquid-crystal layer 130. The pixel electrode layer 123 is disposed on a surface on one side of the second insulating layer 125 adjacent to the liquid-crystal layer 130. Among them, the pixel electrodes 1231 on the pixel electrode layer 123 can be electrically connected to the corresponding thin-film transistors 1213 in the display driving structure 121 through the through holes provided in the first insulating layer 124 and the second insulating layer 125. The display driving structure 121, the first insulating layer 124, the common electrode layer 122, the second insulating layer 125, and the pixel electrode layer 123 are disposed sequentially from bottom to top on a surface on one side of the second substrate 120 adjacent to the liquid-crystal layer 130.

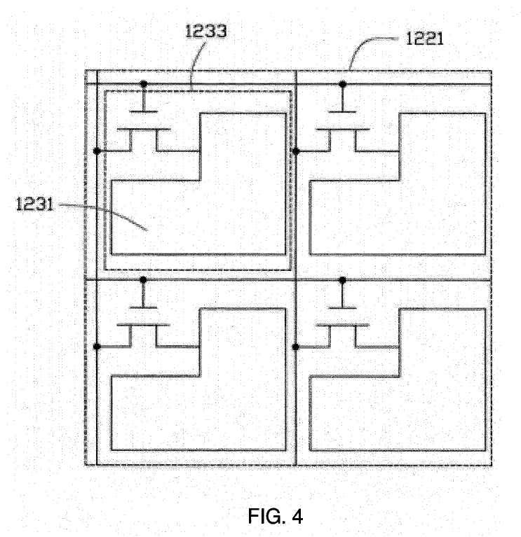

The common electrode layer 12 includes a plurality of common electrodes 1221 arranged in a matrix. The common electrodes 1221 have a dot shape or a block shape. Referring to FIG. 4, FIG. 4 is a schematic diagram showing the correspondence between the common electrode shown in FIG. 2 and the pixel region shown in FIG. 3. As shown in FIG. 4, each common electrode 1221 can correspond to four pixels 1233. During the display period of the embedded touch display panel 100, each common electrode 1221 is configured to work with the pixel electrodes 1231 in the four pixels 1233 to drive the four pixels to display. It should be understood that, in other embodiments, the correspondence of the common electrodes 1221 and the pixels 1233 may be other modes, and is not limited to the correspondence as shown in FIG. 4. For example, each common electrode 1221 corresponds to 6 or 8 pixels, etc. It should be understood that, in other embodiments, the arrangement of the common electrodes 1221 may also be a non-matrix arrangement.

The common electrodes 1221 in the common electrode layer 122 is configured to sense the touch operation during the touch period of the embedded touch display panel 100. In other words, in the display period of the embedded touch display panel 100, the common electrodes 1221 in the common electrode layer 122 are used as driving electrodes for image display and are applied with a common voltage, and then the pixel electrodes 1231 work with the pixel electrodes 1231 to drive the liquid-crystal molecules in the liquid-crystal layer 130 to rotate to implement display functions. In the touch period of the embedded touch display panel 100, the common electrodes 1221 in the common electrode layer 122 are used to detect touch operations.

One embodiment of the present application provides a compensation method applicable to an embedded touch display panel. The embedded touch display panel includes a plurality of pixel regions and a plurality of common electrodes 1221, and the plurality of pixel regions are in one-to-one correspondence with the plurality of common electrodes 1221. Among them, each pixel region includes a plurality of pixels 1233. For details, please refer to the above description of the embedded touch display panel.

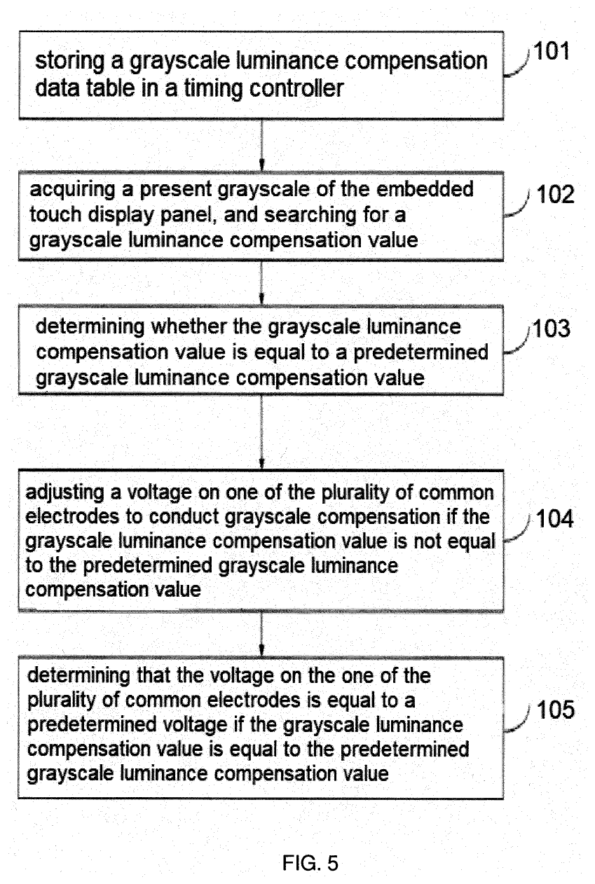

Referring to FIG. 5, FIG. 5 is a schematic flowchart of a compensation method of the present application according to one preferred embodiment of the present application. As shown in FIG. 5, the compensation method includes the following steps:

In Step 101, a grayscale luminance compensation data table is stored in a timing controller. The grayscale luminance compensation data table is used for grayscale compensation on the embedded touch display panel.

In Step 102, a present grayscale of the embedded touch display panel is acquired, and a grayscale luminance compensation value corresponding to the present grayscale in each of the plurality of pixel regions is searched for from the grayscale luminance compensation data table according to the present grayscale of the embedded touch display panel.

In Step 103, whether the grayscale luminance compensation value corresponding to the present grayscale in each of the plurality of pixel regions is equal to a predetermined grayscale luminance compensation value is determined.

In Step 104, a voltage on one of the plurality of common electrodes corresponding to a corresponding one of the plurality of pixel regions to conduct grayscale compensation on the present grayscale of the embedded touch display panel is adjusted if the grayscale luminance compensation value corresponding to the present grayscale in each of the plurality of pixel regions is not equal to the predetermined grayscale luminance compensation value.

More particularly, in Step 101, the grayscale luminance compensation data table includes a grayscale luminance compensation value of each of the plurality of pixel regions with a grayscale from 0-255. That is, grayscale luminance compensation values of the embedded touch display panel on all grayscales are stored in the timing controller. Furthermore, the grayscale luminance compensation value of a pixel region is an average value of the grayscale luminance compensation values of all the pixels in the pixel region.

For example, a pixel region including four pixels is taken as an example. The grayscale luminance compensation value of the first pixel region of the embedded touch display panel is the average value of the grayscale luminance compensation values corresponding to all the pixels in the first pixel region, the grayscale luminance compensation value of the second pixel region of the embedded touch display panel is the average value of the grayscale luminance compensation values corresponding to all the pixels in the second pixel region, and so on. Likewise, the grayscale luminance compensation value of the other pixel region of the embedded touch display panel is the average value of the grayscale luminance compensation values corresponding to all the pixels in the corresponding pixel region.

Preferably, the grayscale luminance compensation data table includes N grayscale luminance compensation data sub-tables. N represents the number of grayscales of the embedded touch display panel, and an Mth grayscale luminance compensation data sub-table is used to conduct grayscale compensation on the embedded touch display panel when a grayscale of the embedded touch display panel is M. By dividing the grayscale luminance compensation data table into N grayscale luminance compensation data sub-tables corresponding to the number of grayscales of the embedded touch display panel, the grayscale luminance compensation data table is more standardized and stored in the timing controller in an orderly manner.

In Step 102, the present grayscale of the embedded touch display panel is acquired, and the grayscale luminance compensation value corresponding to the present grayscale in each of the plurality of pixel regions is searched for from the grayscale luminance compensation data table according to the present grayscale of the embedded touch display panel.

For example, when the present grayscale of the embedded touch display panel is 32, the grayscale luminance compensation value of the first pixel region at grayscale 32 is searched for according to the present grayscale of the embedded touch display panel from the grayscale luminance compensation data table, the grayscale luminance compensation value of the second pixel region at grayscale 32 is searched for according to the present grayscale of the embedded touch display panel from the grayscale luminance compensation data table, and so on, until the grayscale luminance compensation values of all the pixel regions on the embedded touch display panel at grayscale 32 are searched for.

Preferably, the step of searching, from the grayscale luminance compensation data table, for the grayscale luminance compensation value corresponding to the present grayscale in each of the plurality of pixel regions according to the present grayscale of the embedded touch display panel includes: acquiring a corresponding grayscale luminance compensation data sub-table according to the present grayscale of the embedded touch display panel, and searching, from the grayscale luminance compensation data sub-table, for the grayscale luminance compensation value corresponding to each of the plurality of pixel regions.

For example, when the present grayscale of the embedded touch display panel is 32, the 32th grayscale luminance compensation data sub-table is acquired according to the present grayscale of the embedded touch display panel, the grayscale luminance compensation value corresponding to the first pixel region is searched for from the 32th grayscale luminance compensation data sub-table, the grayscale luminance compensation value corresponding to the second pixel region is searched for from the 32th grayscale luminance compensation data sub-table, and so on, until the grayscale luminance compensation values corresponding to all of the pixel regions on the embedded touch display panel are searched for.

In Step 103, whether the grayscale luminance compensation value corresponding to the present grayscale in each of the plurality of pixel regions is equal to the predetermined grayscale luminance compensation value is determined. More particularly, the predetermined grayscale luminance compensation value can be set as needed. For example, the predetermined grayscale luminance compensation value can be set to “0”, and the grayscale luminance compensation value corresponding to each pixel region of the embedded touch display panel in Step 102 is compared with the predetermined grayscale luminance compensation value.

In Step 104, the voltage on one of the plurality of common electrodes corresponding to a corresponding one of the plurality of pixel regions to conduct grayscale compensation on the present grayscale of the embedded touch display panel is adjusted if the grayscale luminance compensation value corresponding to the present grayscale in each of the plurality of pixel regions is not equal to the predetermined grayscale luminance compensation value.

For example, the first pixel region of the embedded touch display panel is taken as an example. The grayscale luminance compensation value of the first pixel region of the embedded touch display panel is “3”. When the predetermined grayscale luminance compensation value is “0”, i.e., the grayscale luminance compensation value of the first pixel region of the embedded touch display panel is not equal to the predetermined grayscale luminance compensation value, the voltage on the common electrode corresponding to the first pixel region is adjusted to conduct grayscale compensation on the embedded touch display panel.

Furthermore, the step of adjusting the voltage on the one of the plurality of common electrodes corresponding to the corresponding one of the plurality of pixel regions to conduct grayscale compensation on the present grayscale of the embedded touch display panel includes: acquiring a common electrode voltage corresponding to the corresponding one of the plurality of pixel regions according to the grayscale luminance compensation value corresponding to the present grayscale in the corresponding one of the plurality of pixel regions; and outputting the common electrode voltage to the one of the plurality of common electrodes corresponding to the corresponding one of the plurality of pixel regions.

For example, the first pixel region of the embedded touch display panel is taken as an example. If the difference between the grayscale luminance compensation value of the first pixel region of the embedded touch display panel and the predetermined grayscale luminance compensation value is “3”, the voltage on the common electrode corresponding to the first pixel region is correspondingly adjusted by 3V.

The compensation method further includes Step 105, in which that the voltage on the one of the plurality of common electrodes corresponding to the corresponding one of the plurality of pixel regions is equal to a predetermined voltage is determined if the grayscale luminance compensation value corresponding to the present grayscale in each of the plurality of pixel regions is equal to the predetermined grayscale luminance compensation value. More particularly, the predetermined voltage can be set as needed.

The compensation method of the present application store a grayscale luminance compensation data table in a timing controller, acquire a present grayscale of the embedded touch display panel, and search, from the grayscale luminance compensation data table, for a grayscale luminance compensation value corresponding to the present grayscale in each of the plurality of pixel regions according to the present grayscale of the embedded touch display panel, determine whether the grayscale luminance compensation value corresponding to the present grayscale in each of the plurality of pixel regions is equal to a predetermined grayscale luminance compensation value, and adjust a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value. Compared with the conventional technology, the present application only needs to store the grayscale luminance compensation value corresponding to each pixel region, and the stored amount of data is relatively small and can be stored in the timing controller of the embedded touch display panel, which can reduce the product cost while improving the display performance of the embedded touch display panel.

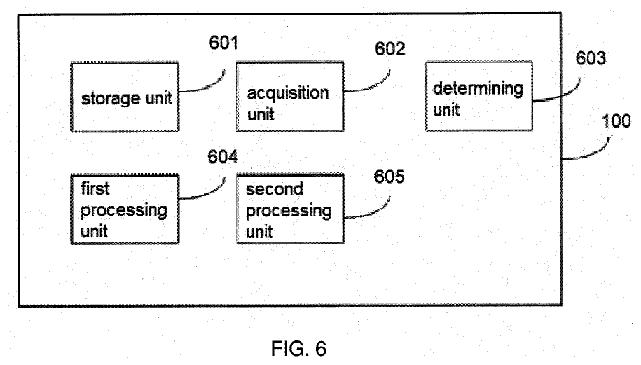

Moreover, referring to FIG. 6, FIG. 6 is a schematic diagram of an embedded touch display panel according to one preferred embodiment of the present application. As shown in FIG. 6, the embedded touch display panel 100 according to one embodiment of the present application further includes a storage unit 601, an acquisition unit 602, a determining unit 603, a first processing unit 604, and a second processing unit 605.

The storage unit 601 is configured to store a grayscale luminance compensation data table in a timing controller, and the grayscale luminance compensation data table is used for grayscale compensation on the embedded touch display panel.

The acquiring unit 602 is configured to acquire a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel.

The determining unit 603 is configured to determine whether the grayscale luminance compensation value corresponding to the present grayscale in each of the plurality of pixel regions is equal to a predetermined grayscale luminance compensation value.

The first processing unit 604 is configured to adjust a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value.

The second processing unit 605 is configured to determine that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value.

The first processing unit 604 is further configured to: acquire a common electrode voltage corresponding to the corresponding one of the plurality of pixel regions according to the grayscale luminance compensation value corresponding to the present grayscale in the corresponding one of the plurality of pixel regions; and output the common electrode voltage to the one of the plurality of common electrodes corresponding to the corresponding one of the plurality of pixel regions.

The above is a detailed description of the compensation method and the embedded touch display panel of one embodiment of the present application. In this specification, specific examples are provided to explain the principles and implementations of the present application. However, the description of the above embodiments is only used to help understanding the present application. Meanwhile, for those skilled in the art, there will be modifications in specific implementations and application scope according to the idea of the present application. In summary, the contents of this specification should not be construed as a limitation of the present application.

What is claimed is:

1. A compensation method applicable to an embedded touch display panel comprising a plurality of pixel regions and a plurality of common electrodes in one-to-one correspondence, the compensation method comprising:
storing a grayscale luminance compensation data table in a timing controller, the grayscale luminance compensation data table being used for grayscale compensation on the embedded touch display panel;
acquiring a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;
determining whether the grayscale luminance compensation value corresponding to the present grayscale in each of the plurality of pixel regions is equal to a predetermined grayscale luminance compensation value;
adjusting a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value;
the compensation method further comprising:
determining that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value;
wherein each of the plurality of pixel regions comprises a plurality of pixels, and the grayscale luminance compensation value of one of the plurality of pixel regions is an average value of grayscale luminance compensation values of the plurality of pixels in one of the plurality of pixel regions.

2. The compensation method according to claim 1, wherein the step of adjusting the voltage on the one of the plurality of common electrodes corresponding to the corresponding one of the plurality of pixel regions to conduct grayscale compensation on the present grayscale of the embedded touch display panel comprises:
acquiring a common electrode voltage corresponding to the corresponding one of the plurality of pixel regions according to the grayscale luminance compensation value corresponding to the present grayscale in the corresponding one of the plurality of pixel regions; and
outputting the common electrode voltage to the one of the plurality of common electrodes corresponding to the corresponding one of the plurality of pixel regions.

3. The compensation method according to claim 1, wherein the grayscale luminance compensation data table comprises N grayscale luminance compensation data-sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

4. The compensation method according to claim 3, wherein the step of searching, from the grayscale luminance compensation data table, for the grayscale luminance compensation value corresponding to the present grayscale in each of the plurality of pixel regions according to the present grayscale of the embedded touch display panel comprises:
acquiring a corresponding grayscale luminance compensation data sub-table according to the present grayscale of the embedded touch display panel;
searching, from the grayscale luminance compensation data sub-table, for the grayscale luminance compensation value corresponding to each of the plurality of pixel regions.

5. The compensation method according to claim 1, wherein the grayscale luminance compensation data table comprises the grayscale luminance compensation value of each of the plurality of pixel regions with a grayscale from 0-255.

6. A compensation method applicable to an embedded touch display panel comprising a plurality of pixel regions and a plurality of common electrodes in one-to-one correspondence, the compensation method comprising:
storing a grayscale luminance compensation data table in a timing controller, the grayscale luminance compensation data table being used for grayscale compensation on the embedded touch display panel;
acquiring a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;
determining whether the grayscale luminance compensation value corresponding to the present grayscale in each of the plurality of pixel regions is equal to a predetermined grayscale luminance compensation value; and
adjusting a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value.

7. The compensation method according to claim 6, wherein the compensation method, further comprising:
determining that the voltage on the one of the plurality of common electrodes corresponding to the corresponding one of the plurality of pixel regions is equal to a predetermined voltage if the grayscale luminance compensation value, corresponding to the present grayscale in each of the plurality of pixel regions is equal to the predetermined grayscale luminance compensation value.

8. The compensation method according to claim 7, wherein the step of adjusting the voltage on the one of the plurality of common electrodes corresponding to the corresponding one of the plurality of pixel regions to conduct grayscale compensation on the present grayscale of the embedded touch display panel comprises:
acquiring a common electrode voltage corresponding to the corresponding one of the plurality of pixel regions according to the grayscale luminance compensation value corresponding to the present grayscale in the corresponding one of the plurality of pixel regions; and
outputting the common electrode voltage to the one of the plurality of common electrodes corresponding to the corresponding one of the plurality of pixel regions.

9. The compensation method according to claim 6, wherein the grayscale luminance compensation data table comprises N grayscale luminance compensation data sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

10. The compensation method according to claim 9, wherein the step of searching, from the grayscale luminance compensation data table, for the grayscale luminance compensation value corresponding to the present grayscale in each of the plurality of pixel regions according to the present grayscale of the embedded touch display panel comprises:
acquiring a corresponding grayscale luminance compensation data sub-table according to the present grayscale of the embedded touch display panel; and
searching, from the grayscale luminance compensation data sub-table, for the grayscale luminance compensation value corresponding to each of the plurality of pixel regions.

11. The compensation method according to claim 6, wherein each of the plurality of pixel regions comprises a plurality of pixels, and the grayscale luminance compensation value of one of the plurality of pixel regions is an average value of grayscale luminance compensation values of the plurality of pixels in one of the plurality of pixel regions.

12. The compensation method according to claim 11, wherein the grayscale luminance compensation data table comprises the grayscale luminance compensation value of each of the plurality of pixel regions with a grayscale from 0-255.

13. An embedded touch display panel comprising a plurality of pixel regions and a plurality of common electrodes in one-to-one correspondence, wherein the embedded touch display panel further comprises:
a storage unit configured to store a grayscale luminance compensation data table in a timing controller, the grayscale luminance compensation data table being used for grayscale compensation on the embedded touch display panel;
an acquisition unit configured to acquire a present grayscale of the embedded touch display panel, and searching, from the grayscale luminance compensation data table, for a grayscale luminance compensation value corresponding to the present grayscale in each of the plurality of pixel regions according to the present grayscale of the embedded touch display panel;
a determining unit configured to determine whether the grayscale luminance compensation value corresponding to the present grayscale in each of the plurality of pixel regions is equal to a predetermined grayscale luminance compensation value; and
a first processing unit configured to adjust a voltage on one of the plurality of common electrodes corresponding to a corresponding one of the plurality of pixel regions to conduct grayscale compensation on the present grayscale of the embedded touch display panel if the grayscale luminance compensation value corresponding to the present grayscale in each of the plurality of pixel regions is not equal to the predetermined grayscale luminance compensation value.

14. The embedded touch display panel according to claim 13, further comprising:
a second processing unit configured to determine that the voltage on the one of the plurality of common electrodes corresponding to the corresponding one of the plurality of pixel regions is equal to a predetermined voltage if the grayscale luminance compensation value corresponding to the present grayscale in each of the plurality of pixel regions is equal to the predetermined grayscale luminance compensation value.

15. The embedded touch display panel according to claim 14, wherein the first processing unit is further configured to:
acquire a common electrode voltage corresponding to the corresponding one of the plurality of pixel regions according to the grayscale luminance compensation value corresponding to the present grayscale in the corresponding one of the plurality of pixel regions; and
output the common electrode voltage to the one of the plurality of common electrodes corresponding to the corresponding one of the plurality of pixel regions.

16. The embedded touch display panel according to claim 13, wherein the grayscale luminance compensation data table comprises N grayscale luminance compensation data sub-tables, wherein N represents the number of grayscales of the embedded touch display panel, and an Mth grayscale luminance compensation data sub-table is used to conduct grayscale compensation on the embedded touch display panel when a grayscale of the embedded touch display panel is M.

17. The embedded touch display panel according to claim 16, wherein the acquisition unit is further configured to:
acquire a corresponding grayscale luminance compensation data sub-table according to the present grayscale of the embedded touch display panel; and
search, from the grayscale luminance compensation data sub-table, for the grayscale luminance compensation value corresponding to each of the plurality of pixel regions.

18. The embedded touch display panel according to claim 13, wherein each of the plurality of pixel regions comprises a plurality of pixels, and the grayscale luminance compensation value of one of the plurality of pixel regions is an average value of grayscale luminance compensation values of the plurality of pixels in one of the plurality of pixel regions.

19. The embedded touch display panel according to claim 18, wherein the grayscale luminance compensation data table comprises the grayscale luminance compensation value of each of the plurality of pixel regions with a grayscale from 0-255.
